(19) United States
(12) Patent Application Publication
(10) Pub. No.: US 2010/0161858 A1
(43) Pub. Date: Jun. 24, 2010

(54) ADDRESS CONVERSION SYSTEM AND METHOD

(75) Inventors: CHIH-WEI HSIEH, Tu-Cheng (TW); WEI-CHU LAI, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/353,977

(22) Filed: Jan. 15, 2009

(30) Foreign Application Priority Data
Dec. 24, 2008 (CN) 200810306502.1

(51) Int. Cl. G06F 13/00

(52) U.S. Cl. 710/104

(57) ABSTRACT

An address conversion system is applied for a numerical control device and connected between a software inner address unit and a hardware contact point address unit. The address conversion system includes an address editing unit and an address conversion unit. The address editing unit includes an address display module and an address editing module. The address display module is configured for displaying hardware device startup addresses stored in the software inner address unit via an address display interface. The address editing module is configured for displaying contact point addresses stored in the hardware contact point address unit via an address editing interface. The contact point addresses are capable of being amended in the address editing interface. The address conversion unit is configured for matching the hardware device startup addresses with the corresponding contact point address.

### BACKGROUND

1. Technical Field

The present disclosure relates to conversion systems and conversion methods and, more particularly, to an address conversion system and an address conversion method.

2. Description of the Related Art

During the operations of numerical control devices, a mismatch of a hardware device startup address with a contact point address often occurs. Once this happens, the operator has to change the contact point address or the hardware device startup address manually, which is inconvenient.

### BRIEF DESCRIPTION OF THE DRAWINGS

FIG. 1 is a block diagram of an exemplary embodiment of an address conversion system.

FIG. 2 is a schematic diagram of a first exemplary embodiment of an original address editing unit of the address conversion system of FIG. 1.

FIG. 3 is a schematic diagram of an amended address editing unit of the address conversion system of FIG. 1.

FIG. 4 is a schematic diagram of a second exemplary embodiment of an address editing unit of the address conversion system of FIG. 1.

FIG. 5 is a flowchart of an exemplary embodiment of an address conversion method.

### DETAILED DESCRIPTION

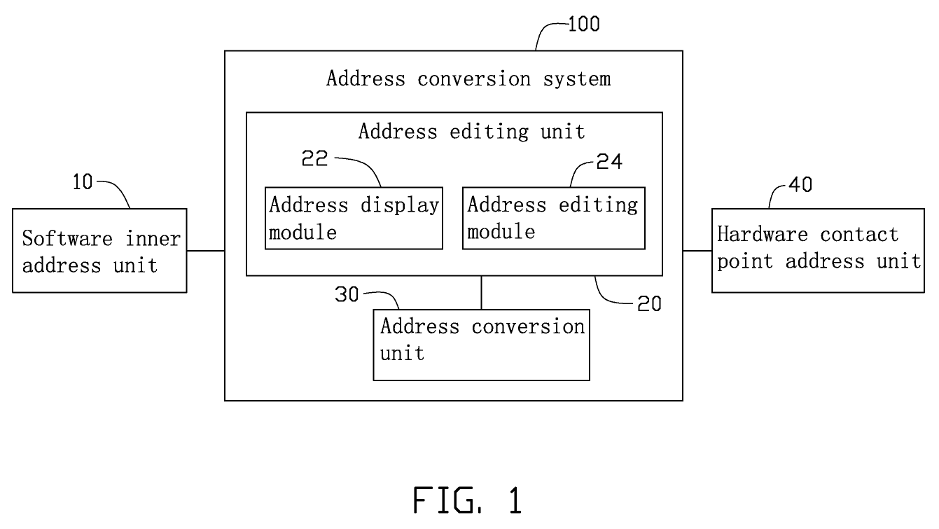

Referring to FIGS. 1 to 4, an exemplary embodiment of an address conversion system 100 is configured for matching hardware device startup addresses stored in a controller with contact point addresses of corresponding hardware devices. The address conversion system 100 is connected between a software inner address unit 10 and a hardware contact point address unit 40 of the controller. When a hardware device startup address stored in the controller is invoked by software of the controller, a hardware device corresponding to the hardware startup address will be started. The address conversion system 100 includes an address editing unit 20 and an address conversion unit 30.

A plurality of hardware device startup addresses is stored in the software inner address unit 10. A plurality of contact point addresses is stored in the hardware contact point address unit 40. Each of the plurality of hardware startup addresses stored in the software inner address unit 10 is corresponding to one of the plurality of the contact point addresses stored in the hardware contact point unit 40. Each of the plurality of contact point addresses stored in the hardware contact point unit 40 is corresponding to one of a plurality of contact points connected to the hardware devices.

The address editing unit 20 includes an address display module 22 and an address editing module 24. The address display module 22 is configured for displaying the hardware device startup addresses stored in the software inner address unit 10 via an address display interface 222, and displaying names of the corresponding hardware devices. The address editing module 24 is configured for displaying the contact point addresses stored in the hardware contact point unit 40 via an address editing interface 242, and editing the contact point addresses displayed in the address editing interface 242.

The address editing interface 242 includes a plurality of dialog boxes 244. Each of the plurality of dialog boxes 244 is configured for displaying one of the plurality of contact point addresses stored in the hardware contact point address unit 40. The plurality of contact point addresses can be amended in the corresponding dialog boxes 244. The number of the plurality of dialog boxes 244 of the address editing interface 242 is equal to the number of the plurality of contact point address stored in the hardware contact point unit 40.

The address conversion unit 30 is configured for matching the hardware device startup addresses displayed in the address display interface 222 with the contact point addresses displayed in the corresponding dialog boxes 244. Namely, when one of the plurality of hardware device startup addresses is invoked by software, the address conversion unit 30 matches the hardware device startup address with a contact point address displayed in a dialog box in alignment with the invoked hardware device startup address in the address display interface 222. A corresponding hardware device will be started.

When the hardware device startup addresses displayed in the address display interface 222 fail to match with the contact point addresses displayed in the dialog boxes 244 corresponding to the hardware device startup address, the contact point addresses can be amended in the corresponding dialog boxes 244 to match with the hardware device startup addresses to start the corresponding hardware devices.

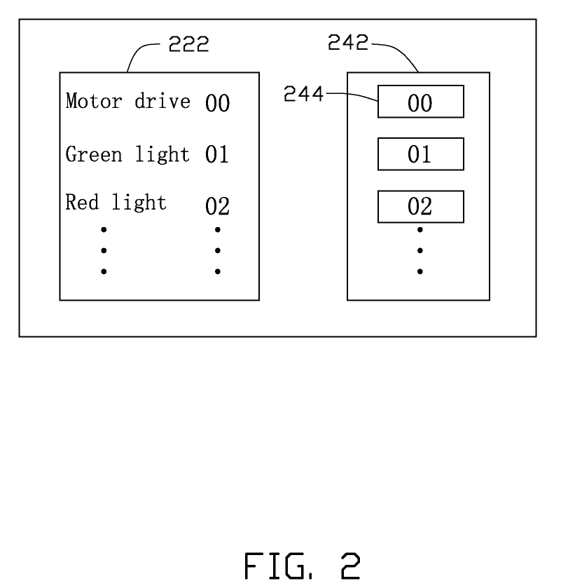

For example, referring to FIG. 2, the names of the hardware devices, such as motor drive, green light, and red light, and corresponding hardware startup addresses 00, 01, 02 stored in the software inner address unit 10 are displayed in the address display interface 222 as motor drive 00, green light 01, and red light 02. The contact point addresses 00, 01, 02, stored in the hardware contact point address unit 40 are displayed in the dialog boxes 244 corresponding to the motor drive 00, the green light 01, and the red light 02 respectively. When the motor drive startup address 00 is invoked, the address conversion unit 30 matches the motor drive startup address 00 with the contact point address 00 stored in the dialog box 244 in alignment with the motor drive startup address 00 in the address display interface 222. If the motor drive operates, this indicates that the motor drive startup address 00 matches with the motor drive, and the contact point address of the motor drive is 00. When the green light startup address 01 is invoked, the address conversion unit 30 matches the green light startup address 01 with the contact point address 01 stored in the dialog box 244 in alignment with the green light startup address 01 in the address display interface 222. If the red light shines, it indicates that the green light startup address 01 fails to match with the red light, and the contact point address of the red light is 01. When the red light startup address 02 is invoked, the address conversion unit 30 matches the red light startup address 02 with the contact point address 02 stored in the dialog box 244 in alignment with the red light startup address 02 in the address display interface 222. If the green light shines, it indicates that the red light address 02 fails to match with the green light, and the contact point address of the green light is 02.

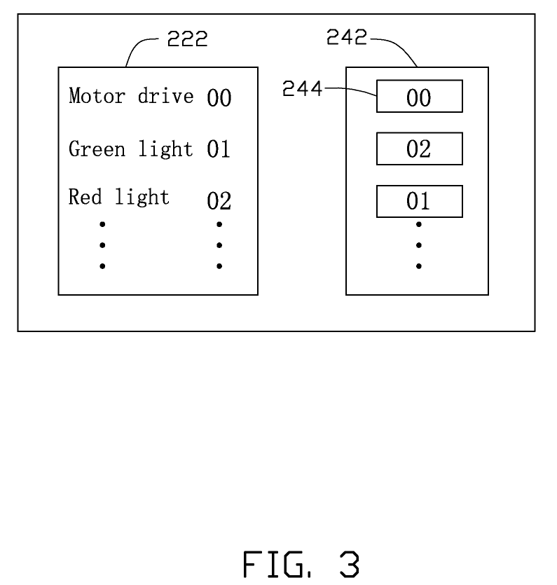

Referring to FIG. 3, according to the above status that the hardware device startup addresses 01 and 02 displayed in the address display interface 222 failed to match with the corresponding hardware devices, the contact point address 01 in the dialog box 244 in alignment with the green light startup address 01 is changed into the contact point address 02, and the contact point address 02 in the dialog box 244 in alignment with the red light startup address 02 is changed into the contact point address 01. When the green light startup address 01 is invoked, the address conversion unit 30 matches the green light startup address 01 with the contact point address 02 displayed in the dialog box 244 in alignment with the green light startup address 01. The green light shines. When the red light startup address 02 is invoked to start, the address conversion unit 30 matches the red light startup address 02 displayed in the address display interface 222 with the contact point address 01 displayed in the dialog box 244 in alignment with the red light startup address 02. The red light shines.

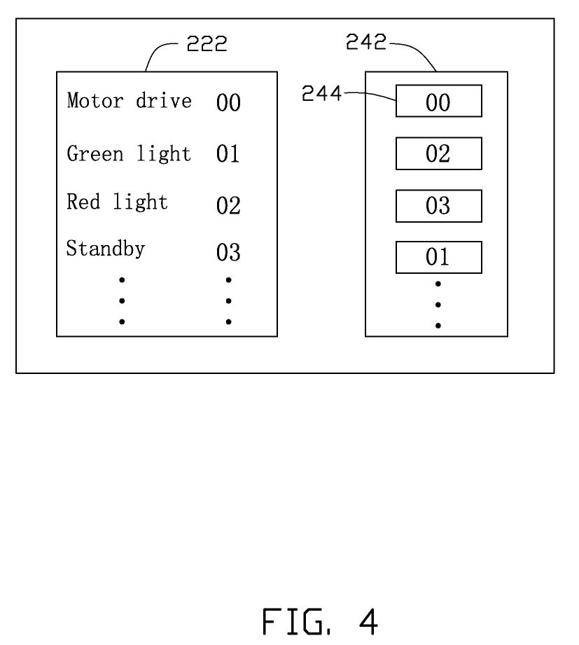

The address conversion system 100 can also use standby addresses, such as a standby address 03 stored in the software inner address unit 10 and a standby contact point address 03, to realize address conversion match. For example, referring to FIG. 4, if a contact point of the red light is broken, namely, when the red light startup address 02 is invoked, the light fails to shine. A connection line of the red light can be connected to the standby contact point whose contact point address 03 is stored in the hardware contact point unit 40. The standby contact point address 03 in the dialog box 244 in alignment with the standby address 03 in the address display interface 222 is changed into the contact point address 01 of the red light. The contact point address 01 in the dialog box 244 in alignment with the red light startup address 02 in the address display interface 222 is changed into the standby contact point address 03. When the red light startup address 02 is invoked, the address conversion unit 30 matches the red light startup address 02 with the standby contact point address 03 displayed in the dialog box 244 in alignment with the red light startup address 02 in the address display interface 222. The red light shines.

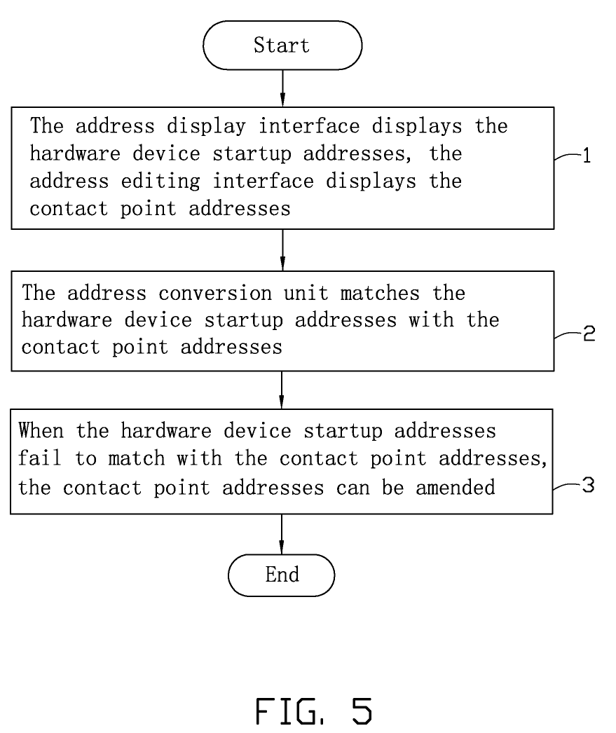

Referring to FIG. 5, an exemplary address conversion method utilizing the above-mentioned address conversion system for matching the hardware device startup addresses with the contact point addresses includes the follow steps.

In block 1, the hardware device startup addresses stored in the software inner address unit 10 are displayed in the address display interface 222, and the contact point addresses stored in the hardware contact point address unit 40 are displayed in the corresponding dialog boxes 244 of the address editing interface 242.

In block 2, the address conversion unit 30 matches the hardware device startup addresses with the contact point addresses displayed in the dialog boxes 244 in alignment with the hardware device startup addresses in the address display interface 222.

In block 3, if the hardware device startup addresses fail to match with the contact point addresses, the contact point addresses are amended in the corresponding dialog boxes 244 to match with the hardware device startup addresses.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. An address conversion system for a numerical control device and connected between a software inner address unit and a hardware contact point address unit, comprising:
an address editing unit comprising:
an address display module configured for displaying hardware device startup addresses stored in the software inner address unit via an address display interface; and
an address editing module configured for displaying contact point addresses stored in the hardware contact point address unit via an address editing interface, wherein the contact point addresses are capable of being amended in the address editing interface; and
an address conversion unit configured for matching the hardware device startup addresses with the corresponding contact point addresses.

2. The address conversion system of claim 1, wherein the number of the hardware device startup addresses stored in the software inner address unit is equal to the number of the contact point addresses stored in the hardware contact point address unit.

3. The address conversion system of claim 2, wherein a plurality of dialog boxes is defined in the address editing interface, the number of the dialog boxes is equal to the number of the contact point addresses, each of the plurality of dialog boxes is configured for displaying one contact point address, the address conversion unit is configured for matching the hardware device startup addresses with the contact point addresses displayed in the dialog boxes in alignment with the hardware device startup addresses.

4. The address conversion system of claim 3, wherein at least one standby address is stored in the software inner address unit, at least one dialog box is defined in the address editing interface for the at least one standby address, at least one standby contact point address is stored in the hardware contact point address unit.

5. An address conversion method comprising:
displaying hardware device startup addresses stored in a software inner address unit and contact point addresses stored in a hardware contact point address unit;
matching the hardware device startup addresses with the contact point addresses; and
amending the contact point addresses needed to be amended in response to the hardware device startup addresses failing to match with the contact point addresses.

6. The method of claim 5, wherein the hardware device startup addresses are displayed in an address display interface and the contact point addresses are displayed in an address editing interface.

7. The method of claim 6, wherein a plurality of dialog boxes is defined in the address editing interface, the number of the dialog boxes is equal to the number of the contact point addresses, each of the plurality of dialog boxes is configured for displaying one of the contact point addresses, the contact point addresses can be amended in the corresponding dialog boxes, the hardware device startup addresses are matched with the contact point addresses displayed in the dialog boxes in alignment with the hardware device startup addresses.

8. The method of claim 5, wherein the number of the hardware device startup addresses is equal to the number of the contact point address.
